(19) United States
(12) Patent Application Publication
(10) Pub. No.: US 2026/0255340 A1
(43) Pub. Date: Aug. 27, 2026

(54) DATA CHANNEL SCHEDULING IN WIRELESS COMMUNICATIONS

(71) Applicant: ZTE CORPORATION, Shenzhen, Guangdong (CN)

(72) Inventors: Shuaihua KOU, Shenzhen (CN); Jing SHI, Shenzhen (CN); Xianghui HAN, Shenzhen (CN); Xingguang WEI, Shenzhen (CN)

(21) Appl. No.: 19/489,736

(22) PCT Filed: Jun. 28, 2023
(86) PCT No.: PCT/CN2023/103380

§ 371 Date: Dec. 3, 2025

(51) Int. Cl. H04W 72/1263

(52) U.S. Cl. CPC H04W 72/1263

(57) ABSTRACT

This document generally relates to wireless communication involving a network device that transmits control information to schedule a plurality of data channels transmitted in a plurality of carriers. A user device receives the control information. In addition, the control information indicates a resource of the plurality of data channels, and the plurality of data channels are ordered according to an order determined by at least one of a frequency domain or a time domain. The network device and the user device communicate the plurality of data channels in the plurality of carriers according to the resource and the order.

### CROSS-REFERENCE TO RELATED APPLICATION(S)

The present application is a national phase entry under 35 U.S.C 371 of International Application No. PCT/CN2023/103380, filed on Jun. 28, 2023. The entire contents of the International Patent Application are incorporated herein by reference.

### TECHNICAL FIELD

This document is directed generally to data channel scheduling in wireless communications.

### BACKGROUND

In wireless communication, sidelink, downlink and uplink shared channel repetition can improve reliability. However, such repetition may increase transmission latency. Ways to reduce such transmission latency may be desirable while the reliability can still be guaranteed.

### SUMMARY

This document relates to methods, systems, apparatuses and devices for wireless communication. In some implementations, a method for wireless communication includes: transmitting, by a network device, control information to schedule a plurality of data channels transmitted in a plurality of carriers, wherein the control information indicates a resource of the plurality of data channels, and the plurality of data channels are ordered according to an order determined by at least one of a frequency domain or a time domain; and communicating, by the network device, the plurality of data channels in the plurality of carriers according to the resource and the order.

In some other implementations, a method for wireless communication includes: receiving, by a user device, control information to schedule a plurality of data channels transmitted in a plurality of carriers, wherein the control information indicates a resource of plurality of data channels, and the plurality of data channels are ordered according to an order determined by at least one of a frequency domain or a time domain; and communicating, by the user device, the plurality of data channels in the plurality of carriers according to the resource and the order.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a flow chart of a method for wireless communication.

FIG. 3 shows a flow chart of a method for wireless communication.

FIG. 4 shows a schematic diagram of an example of scheduling a plurality of data channels.

FIG. 5 shows a schematic diagram of another example of scheduling a plurality of data channels.

FIG. 6 shows a schematic diagram of an example of scheduling a plurality of physical downlink shared channels (PDSCHs).

FIG. 7 shows a schematic diagram of another example of scheduling a plurality of PDSCHs.

FIG. 8 shows a schematic diagram of yet another example of scheduling a plurality of PDSCHs.

FIG. 9 shows a schematic diagram of an example of scheduling a plurality of PDSCHs and a plurality of physical uplink shared channels (PUSCHs).

FIG. 10 shows a schematic diagram of yet another example of scheduling a plurality of PDSCHs.

FIG. 11 shows a schematic diagram of yet another example of scheduling a plurality of PDSCHs.

FIG. 12 shows a schematic diagram of yet another example of scheduling data channels.

FIG. 13 shows a schematic diagram of yet another example of scheduling a plurality of data channels.

FIG. 14 is a schematic diagram illustrating yet another example of scheduling data channels.

FIG. 15 is a schematic diagram illustrating yet another example of scheduling data channels.

FIG. 16 is a schematic diagram illustrating yet another example of scheduling data channels.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

The present description describes various embodiments of systems, apparatuses, devices, and methods for wireless communications related to data channel scheduling.

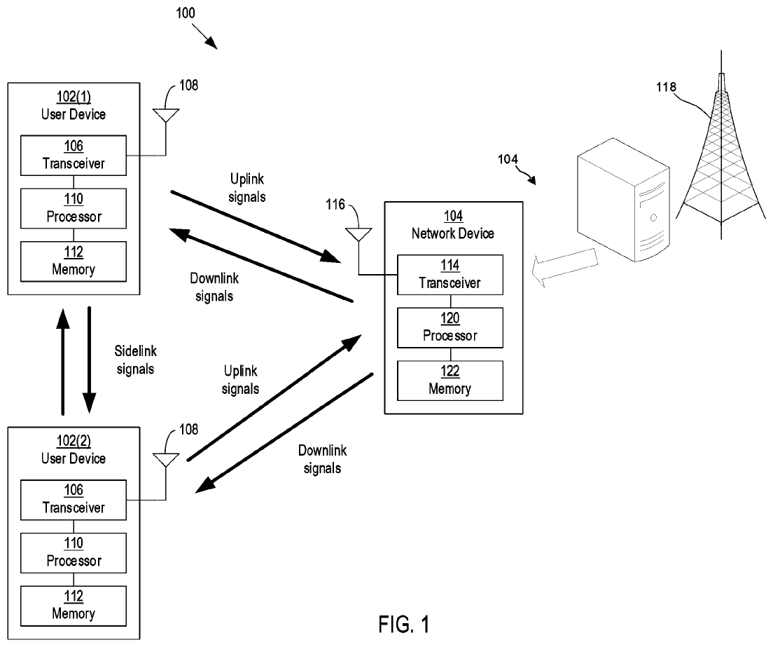

FIG. 1 shows a diagram of an example wireless communication system 100 including a plurality of communication nodes (or just nodes) that are configured to wirelessly communicate with each other. In general, the communication nodes include at least one user device 102 and at least one network device 104. The example wireless communication system 100 in FIG. 1 is shown as including two user devices 102, including a first user device 102(1) and a second user device 102(2), and one network device 104. However, various other examples of the wireless communication system 100 that include any of various combinations of one or more user devices 102 and/or one or more network devices 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples)) or a fixed or stationary device (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the network device 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a network device as described herein, such as the network device 104, may include a single electronic device or apparatus, or multiple (e.g., a network of) electronic devices or apparatuses, and may comprise one or more wireless access nodes, base stations, or other wireless network access points capable of communicating wirelessly over a network with one or more user devices and/or with one or more other network devices 104. For example, the network device 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A network device 104 may include transceiver circuitry 114 coupled to an antenna 116, which may include an antenna tower 118 in various approaches, to effect wireless communication with the user device 102 or another network device 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless communication system 100—such as a user device 102 and a network device 104, two user devices 102 without a network device 104, or two network devices 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless communication system 100, the communication nodes are configured to wirelessly communicate signals between each other. In general, a communication in the wireless communication system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless communication system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a network device 104. A downlink signal is a signal transmitted from a network device 104 to a user device 102. A sidelink signal is a signal transmitted from a one user device 102 to another user device 102, or a signal transmitted from one network device 104 to another network device 104. Also, for sidelink transmissions, a first/source user device 102 directly transmits a sidelink signal to a second/destination user device 102 without any forwarding of the sidelink signal to a network device 104.

Additionally, signals communicated between communication nodes in the wireless communication system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a network device 104 to a user device 102. In other embodiments, the control information includes uplink control information (UCI) that is transmitted in the uplink direction from a user device 102 to a network device 104, or sidelink control information (SCI) that is transmitted in the sidelink direction from one user device 102(1) to another user device 102(2).

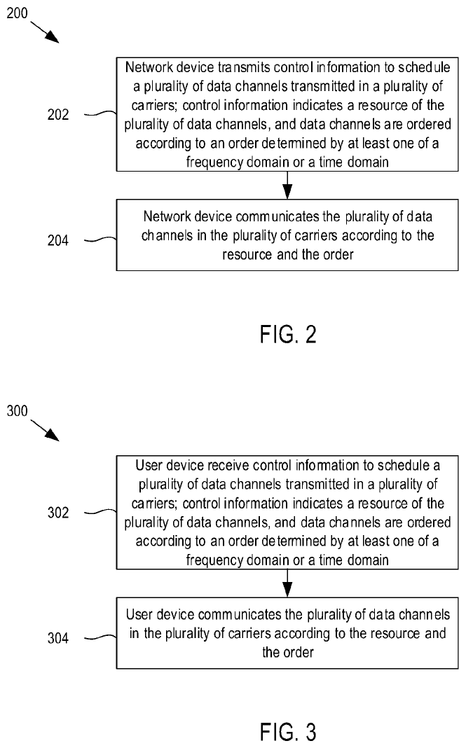

FIG. 2 is a flow chart of an example method 200 for wireless communication that involves data channel scheduling. At block 202, the network device 104 may transmit control information to schedule a plurality of data channels transmitted in a plurality of carriers. The control information may indicate a resource of the plurality of data channels, and the plurality of data channels may be ordered according to an order determined by at least one of a frequency domain or a time domain. At block 204, the network device 104 may communicate (transmit and/or receive) the plurality of data channels in the plurality of carriers according to the resource and the order.

FIG. 3 is a flow chart of an example method 300 for wireless communication that involves data channel scheduling. At block 302, the user device 102 may receive control information to schedule a plurality of data channels transmitted in a plurality of carriers. The control information may indicate a resource of plurality of data channels, and the plurality of data channels may be ordered according to an order determined by at least one of a frequency domain or a time domain. At block 304, the user device 102 may communicate (transmit and/or receive) the plurality of data channels in the plurality of carriers according to the resource and the order.

In some embodiments of the method 200 and/or the method 300, the resource is a resource of a first data channel of the plurality of data channels.

In some embodiments of the method 200 and/or the method 300, the plurality of carriers belong to a serving cell.

In some embodiments of the method 200 and/or the method 300, the plurality of data channels are ordered first according to the time domain, and second according to the frequency domain. In particular of these embodiments, the plurality of data channels are mapped to slots of an initial carrier indicated by the network device 104 according to a slot index until a number the plurality of data channels that are mapped is equal to a value configured by the network device 104 or until a last of the plurality of data channels is mapped. In addition or alternatively, in particular of these embodiments, a set of one or more remaining data channels is unmapped to the slots of the initial carrier when the number of the plurality of data channels that are mapped is equal to the value, and the set is mapped to a next carrier starting from a first slot or a last slot that overlaps with a data channel transmitted in the plurality of carriers indicated by the network device or that overlaps with a slot of a data channel transmitted in the plurality of carriers indicated by the network device.

In some embodiments of the method 200 and/or the method 300, wherein the plurality of data channels are ordered first according to the frequency domain, and second according to the time domain. In particular of these embodiments, the plurality of data channels are mapped to the plurality of carriers in a slot. In addition or alternatively, in particular of these embodiments, the slot is in the plurality of carriers other than a carrier indicated by the network device for the transmission of the plurality of data channels in the plurality of carriers, and the slot includes at least one of the slots from a first slot to a last slot, wherein the first slot or the last slot overlaps with a data channel transmitted in the plurality of carriers indicated by the network device 104 or overlaps with a slot of the data channel transmitted in the plurality of carriers indicated by the network device 104. In addition or alternatively, in particular of these embodiments, a set of one or more remaining data channels is unmapped after the plurality of data channels are mapped to a last carrier in the slot, and the set is mapped to the plurality of carriers starting from a next slot of a first carrier of the plurality of carriers. In addition or alternatively, in particular of these embodiments, a set of one or more remaining data channels is unmapped after the plurality of data channels are mapped to all carriers in the slot, and the set is mapped to the plurality of carriers starting from a next slot of a carrier of the plurality of carriers indicated by the network device.

In some embodiments of the method 200 and/or the method 300, the resource comprises a time domain resource, the network device 104 indicates the time domain resource of a first data channel of the plurality of data channels, and the plurality of data channels are mapped to a plurality of slots consecutively starting from the first data channel. In particular of these embodiments, the plurality of slots are in the plurality of carriers and ordered first according to the frequency domain, and second according to the time domain. In some of these embodiments, the slot of the plurality of slots in the plurality of carriers other than a carrier indicated by the network device 104 includes at least one of the slots from a first slot to a last slot, wherein the first slot or the last slot overlaps with a data channel transmitted in the plurality of carriers indicated by the network device 104 or overlaps with a slot of the data channel transmitted in the plurality of carriers indicated by the network device 104. In other particular of these embodiments, the plurality of slots are in the plurality of carriers and ordered first according to the time domain, and second according to the frequency domain. In some of these embodiments, the slot of the plurality of slots in the plurality of carriers other than a carrier indicated by the network device 104 starts from a first slot or a last slot that overlaps with a data channel transmitted in the plurality of carriers indicated by the network device 104 or that overlaps with a slot of the data channel transmitted in the plurality of carriers indicated by the network device 104. In still other particular of these embodiments, a data channel that is mapped to two slots consecutively is split into two parts, wherein a first part is within a first slot and a second part is within a second slot, and the two parts are transmitted separately.

In some embodiments of the method 200 and/or the method 300, a transport block carried in the plurality of data channels is determined by a total resource size of the plurality of data channels. In particular of these embodiments, a set of bits for a plurality of subsequent data channels is selected from a circular buffer by following a last bit for a previous data channel of the plurality of data channels.

In some embodiments of the method 200 and/or the method 300, the plurality of data channels includes at least one of a physical downlink shared channel, a physical uplink shared channel, or a physical sidelink shared channel, and the control information includes at least one of downlink control information, sidelink control information, a medium access control-control element, or radio resource control signaling.

Further details that may be part of or implemented in the method 200 and/or the method 300 are now described.

In some embodiments, the network device 104 may configure a serving cell for a user device 102. The network device 104 may configure the serving cell to include one or more carriers. Each carrier may include a downlink carrier or an uplink carrier. In particular embodiments, the serving cell may include one or more downlink carriers and/or one or more uplink carriers. In any of various embodiments, the number of downlink carriers may be the same as or different than the number of uplink carriers. In addition or alternatively, each carrier may be identified by a carrier index.

Additionally, in at least some embodiments, a hybrid automatic repeat request (HARQ) entity may include and/or be configured to perform a plurality of HARQ processes. Each HARQ process may be identified by a HARQ process number. In a first case of these embodiments, the serving cell may correspond to a HARQ entity. A HARQ process may correspond to a plurality of data channels. In some of these implementations, a first set of N data channels of the plurality of data channels may be transmitted on a first carrier, where N is an integer greater than 0; a second set of N data channels of the plurality of data channels may be transmitted on a second carrier, and so on, where N is an integer greater than 0. In other of these implementations, the plurality of data channels may be transmitted on any of the plurality of carriers. In a second case of these embodiments, the serving cell may correspond to multiple HARQ entities. Each downlink carrier and/or each uplink carrier may correspond to a respective HARQ entity. As such, if the serving cell includes M carriers, there may be M HARQ entities that corresponds to the M carriers, respectively. A HARQ process may correspond to a plurality of data channels. The plurality of data channels may be transmitted on the carrier corresponding to the HARQ entity.

In addition or alternatively, in some embodiments, control information (e.g., a DCI) may schedule one or more data channels (e.g., a plurality of data channels). Each data channel may be transmitted on one of the plurality of carriers. Additionally, each data channel may include at least one of a PDSCH, a PUSCH or a PSSCH. Also, the one or more data channels may carry different transport blocks. For example, different data channels may carry different transport blocks from each other.

In a first scheduling process, control information (e.g., a DCI) may be communicated (transmitted and/or received) to schedule a plurality of data channels on one or more carriers of a plurality of carriers of a serving cell. The plurality of data channels may carry the same transport block(s). That is, the data channels (or transport block(s)) may be transmitted repeatedly. The first data channel may be referred to as a first repetition, the second data channel may be referred to as a second repetition, and so on.

In particular implementations, the control information (e.g., DCI) may indicate a configuration of the first data channel of the plurality of data channels. Also, a configuration of other or subsequent data channels (other than, or subsequent to, the first data channel) may be determined by the configuration of the first data channel. For example, the first configuration of the other or subsequent data channels may be the same as the configuration of the first data channel. The first configuration may include at least one of a modulation and encoding scheme (MCS), transmit power control (TPC), precoding information, a number of layers, or antenna ports. As another example, a second configuration of the other or subsequent data channels may be determined by a rule based on the configuration of the first data channel. The second configuration may include at least a time domain resource location or a frequency domain resource. For example, the network device 104 may indicate a carrier (e.g., a carrier index) of the first data channel. The indicated carrier may be referred to as the reference carrier. The data channel transmitted on the reference carrier may be referred to as reference data channel. Correspondingly, the first data channel of the plurality of data channels is the reference data channel.

For a data channel transmitted in a slot in a carrier, the next data channel may be transmitted in the next slot and/or in the next carrier.

In some embodiments, the plurality of data channels may be ordered according to at least one of a frequency domain or a time domain. For embodiments where the plurality of data channels is ordered according the frequency domain (e.g., according to carrier index), the plurality of data channels may be transmitted on the carriers of the serving cell in the ascending order of carrier index. For such embodiments, suppose the first data channel is transmitted on carrier A, then the next data channel may be transmitted on a next carrier in ascending order (e.g., carrier A+1), and so on. When a given data channel is transmitted on a last carrier (e.g., the carrier with largest carrier index) of the serving cell, then the next data channel following the given data channel may be transmitted on the first carrier (e.g., the carrier with smallest carrier index) of the serving cell. In other of such embodiments, the plurality of data channels may be transmitted on the carriers of the serving cell in a descending order of the carrier index. For such embodiments, suppose a data channel is transmitted on carrier A, then the next data channel may be transmitted on a next carrier in descending order (e.g., carrier A-1), and so on. When a given data channel is transmitted on the first carrier (e.g., the carrier with smallest carrier index) of the serving cell, then the next data channel after the given data channel may be transmitted on the last carrier (e.g., the carrier with largest carrier index) of the serving cell.

Additionally, in some embodiments, the plurality of data channels may be ordered first according to the frequency domain (e.g., carrier index) and second according to the time domain (e.g., slot index). In at least some of these embodiments, the plurality of data channels may be first mapped to (or transmitted in) the carriers of the serving cell in a slot in accordance with the embodiments. In some embodiments, the mapping may start from the carrier indicated by the network device via DCI or RRC signaling. After the plurality of the data channels are mapped (or transmitted) in the last carrier of the serving cell in a slot, in event that there are any unmapped data remain, those unmapped, remaining data channels (if any) may be mapped to (or transmitted in) the carriers in the next slot, and so on. The first data channel in the next slot may be in the carrier with the smallest carrier index or the largest carrier index, depending on the mapping order. In the case of ascending order of the carrier index, the first data channel in the next slot may be in the carrier with smallest carrier index. In the case of the descending order of the carrier index, the first data channel in the next slot may be in the carrier with largest carrier index.

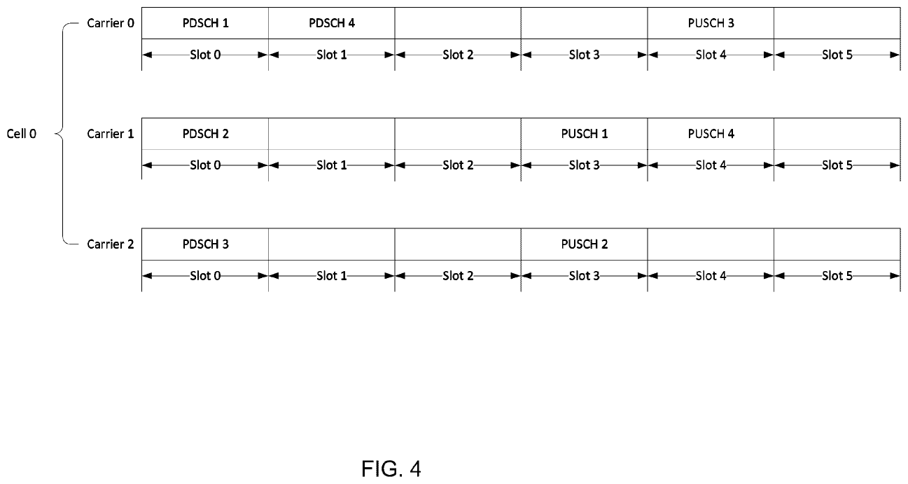

FIG. 4 is a schematic diagram illustrating an example of scheduling a plurality of data channels. In some embodiments of the example in FIG. 4, the network device 104 may configure a serving cell (e.g., cell 0) for the user device 102. Also, in the example, Cell 0 may include three carriers, denoted by carrier 0, carrier 1, and carrier 2, in FIG. 4. Also, the network device 104 may that indicate a certain number of repetitions for PDSCH or PUSCH, such as four in the example in FIG. 4. The network device 104 may indicate the first PDSCH (e.g., PDSCH 1) is transmitted in slot 0 in carrier 0. Based on the rule, the second PDSCH (e.g., PDSCH 2) and the third PDSCH (e.g., PDSCH 3) may be transmitted in slot 0 in carrier 1 and carrier 2, respectively. Then the fourth PDSCH (e.g., PDSCH 4) may be transmitted in slot 1 in carrier 0. The network device 104 may indicate the first PUSCH (e.g., PUSCH 1) is transmitted in slot 3 in carrier 2. Similarly, the second PUSCH (e.g., PUSCH 2) may be transmitted in slot 3 in carrier 2. The third PUSCH (e.g., PUSCH 3) and the fourth PUSCH (e.g., PUSCH 4) may be transmitted on slot 4 in carrier 0, and carrier 1, respectively.

In other embodiments, after the plurality of the data channels are mapped to (or transmitted in) all of the carriers of the serving cell in a slot, then remaining unmapped data channels, if any, may be mapped to (or transmitted in) the carriers in the next slot, and so on. In some of these embodiments, the first data channel in the next slot may be in the carrier indicated by the network device 104. Referring to FIG. 4, the first PUSCH (e.g., PUSCH 1) indicated by the network device 104 may be in slot 3 in carrier 1. Applying the ascending order of the carrier index in a cyclical manner, the second PUSCH (e.g., PUSCH 2), and the third PUSCH (e.g., PUSCH 3) may be in slot 3 in carrier 2, and in slot 3 in carrier 0, respectively. Accordingly, all three carriers are mapped with a PUSCH—i.e., PUSCH 1 is mapped to carrier 1, PUSCH 2 is mapped to carrier 2, and PUSCH 3 is mapped to carrier 0. However, the fourth PUSCH (e.g., PUSCH 4) remains unmapped. In turn, the remaining fourth PUSCH (e.g., PUSCH 4) is in carrier 1 in slot 4 (i.e., the next slot after slot 3). Note, in this example, PUSCH 3 and PUSCH 4 are not illustrated in FIG. 4.

Additionally, in some embodiments, the network device 104 may configure the carriers of the serving cell with different sub-carrier spacing (SCS). For at least some of these embodiments, the data channel on the other carriers is transmitted on the slot that is the first slot overlapping in the time domain with the reference data channel. For situations where the carriers other than the reference carrier have a smaller SCS than the reference carrier, a slot in the carriers other than the reference carrier may be skipped when determining the data channel transmission on the slot when it is already determined that the slot has a data channel since the slot overlaps with a data channel in the previous slot.

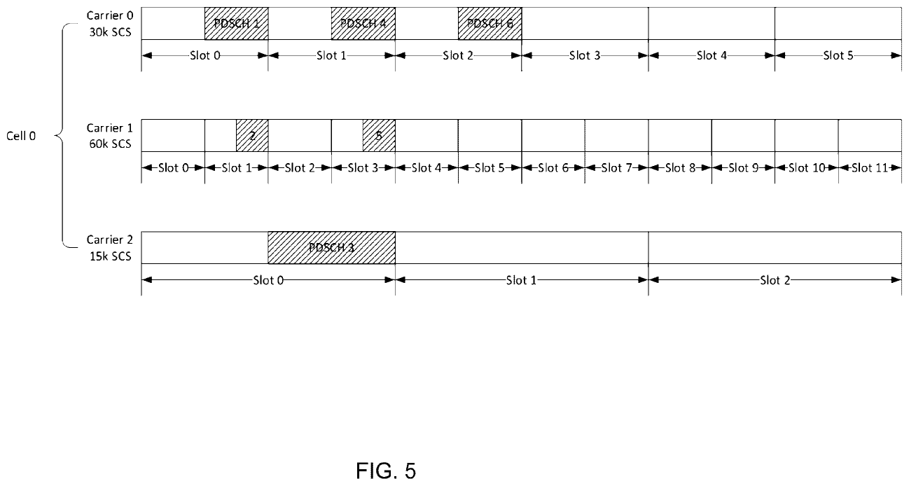

FIG. 5 is a schematic diagram illustrating another example of scheduling data channels. In the example in FIG. 5, in some embodiments, the network device 104 may configure Cell 0 to include: carrier 0 with a 30 kiloHertz (KHz) SCS, carrier 1 with a 60 KHz SCS, and carrier 2 with a 15 kHz SCS. Further, in some configurations such as in FIG. 5 more than one slot in one carrier may correspond to only one slot in another carrier. For example, in FIG. 5, two slots in carrier 1 correspond to one slot in carrier 0; and two slots in carrier 0 correspond to one slot in carrier 2. For at least some of these embodiments, the control information (e.g., DCI) may indicate that the first PDSCH is transmitted in slot 0 in carrier 0. The time resource of the PDSCH is the second half of the slot. For carrier 1, the data channel is transmitted on the first slot that overlaps in the time domain with the first PDSCH in carrier 0. In this example in FIG. 5, the first slot in carrier 1 overlapping with PDSCH 1 is slot 1. Therefore, the second PDSCH (e.g., PDSCH 2) is transmitted in slot 1 in carrier 1 and the time domain resource of the PDSCH 2 is the second half of the slot 2. Slot 0 in carrier 2 overlaps with PDSCH 1 in the time domain. Therefore, the third PDSCH (e.g., PDSCH 3) is transmitted in slot 0 in carrier 2. The fourth PDSCH (e.g., PDSCH 4) is transmitted in slot 1 in carrier 0. Similarly, the fifth PDSCH (e.g., PDSCH 5) is transmitted in slot 3 in carrier 1, which is the first slot overlapping with PDSCH 4 in the time domain.

Further, with respect to FIG. 5, in carrier 2, slot 0 overlaps with PDSCH 4. Since it has already been determined that slot 0 includes PDSCH 3, then slot 0 in carrier 2 is skipped. Therefore, the sixth PDSCH is transmitted in carrier 0. All the PDSCH (e.g., PDSCH 1-6) occupy the second half of the respective slot.

Additionally, in some embodiments, the data channel on the other carriers may be transmitted in the slot that is the first slot overlapping in the time domain with the slot of the data channel transmitted in the reference carrier. To illustrate, still referring to FIG. 5, the slot 0 in carrier 1 is the first slot that overlaps with the slot of PDSCH 1 in carrier 0 (e.g., slot 0 in carrier 0). Therefore, the second PDSCH (e.g., PDSCH 2) is transmitted in slot 0 in carrier 1. Similarly, slot 2 in carrier 1 is the first slot that overlaps with the slot of PDSCH 4 in carrier 0 (e.g., slot 1 in carrier 0). Therefore, the fifth PDSCH (e.g., PDSCH 5) is transmitted in slot 2 in carrier 1. Note, in this example, PUSCH 2 and PUSCH 5 are not illustrated in FIG. 5.

Additionally, in some embodiments, the data channel on the other carriers may be transmitted in the slot that is the slot overlapping in the time domain with the reference data channel.

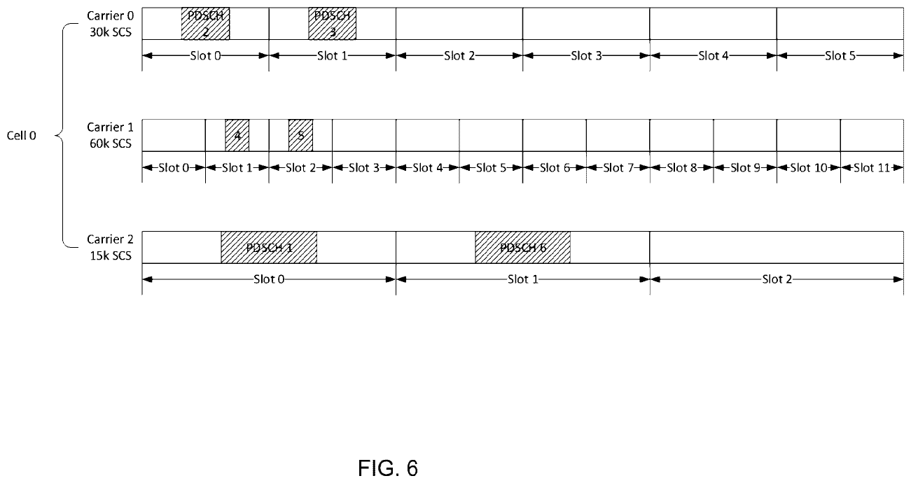

To illustrate, FIG. 6 is a schematic diagram showing an example of scheduling a plurality of PDSCHs. In some of these embodiments, the network device 104 may indicate that PDSCH 1 is transmitted in slot 0 in carrier 2. Correspondingly, carrier 2 may be the reference carrier and PDSCH 1 may be the reference PDSCH. Additionally, in the example in FIG. 6, the plurality of PDSCHs may include six PDSCHs. For carrier 0, both slot 0 and slot 1 overlap with PDSCH 1 in the time domain. Therefore, for carrier 0, the second PDSCH (e.g., PDSCH 2) and the third PDSCH (e.g., PDSCH 3) are in the slot 0 and slot 1, respectively. For carrier 1, both slot 1 and slot 2 overlap with PDSCH 1 in the time domain. Therefore, for carrier 1, the fourth PDSCH (e.g., PDSCH 4) and the fifth PDSCH (e.g., PDSCH 5) are in slot 1 and slot 2, respectively. After all the three carriers are mapped with PDSCH, the next PDSCH (e.g., PDSCH 6) is in slot 1 in carrier 2. Here, PDSCH 6 may be the reference PDSCH.

In addition or alternatively, in some embodiments, the data channel on the other carriers may be transmitted in the slot that is the slot overlapping in the time domain with the slot of the reference data channel.

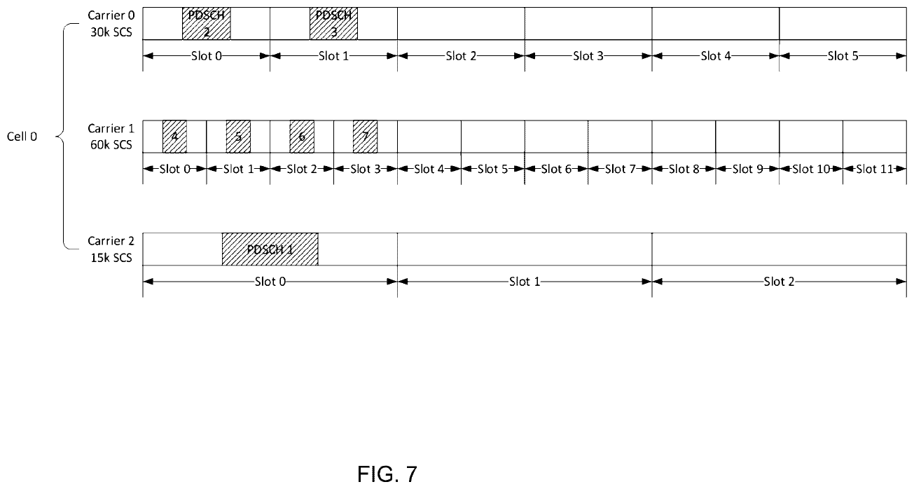

To illustrate, FIG. 7 is a schematic diagram showing an example of scheduling a plurality of PDSCHs. In this example, carrier 2 may be the reference carrier and PDSCH 1 may be the reference PDSCH. For carrier 0, both slot 0 and slot 1 overlap with slot 0 of carrier 2 in the time domain. Therefore, for carrier 0, the second PDSCH (e.g., PDSCH 2) and the third PDSCH (e.g., PDSCH 3) are in the slot 0 and slot 1, respectively. For carrier 1, all of slot 0, slot 1, slot 2 and slot 3 overlap with slot 0 of carrier 2 in the time domain. Therefore, for carrier 1, the fourth PDSCH (e.g., PDSCH 4), the fifth PDSCH (e.g., PDSCH 5), the sixth PDSCH (e.g., PDSCH 6) and the seventh PDSCH (e.g., PDSCH 7) are in slot 0, slot 1, slot 2 and slot 3, respectively.

In addition or alternatively, in some embodiments, the slot for the data channel transmission in the other carriers may include the slots from the first slot that overlaps in the time domain with the reference data channel to the last slot that overlaps in the time domain with the slot of the reference data channel.

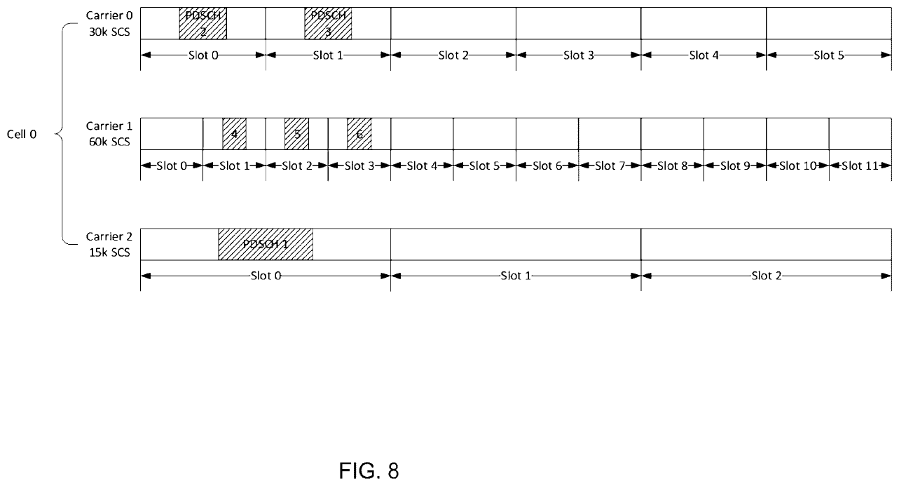

To illustrate, FIG. 8 is a schematic diagram showing an example of scheduling the plurality of PDSCHs. In this example, carrier 2 may be the reference carrier and PDSCH 1 may be the reference PDSCH. For carrier 0, slot 0 is the first slot overlapping with PDSCH 1 in the time domain. Slot 1 of carrier 0 is the last slot overlapping with slot 0 of carrier 2 in the time domain. Therefore, the plurality of PDSCHs are transmitted in slot 0 and slot 1 in carrier 0, which are PDSCH 2 and PDSCH 3, respectively. For carrier 1, slot 1 is the first slot overlapping with PDSCH 1 in the time domain. Slot 3 of carrier 1 is the last slot overlapping with slot 0 of carrier 2 in the time domain. Therefore, the plurality of PDSCHs are transmitted in slot 1, slot 2 and slot 3 in carrier 1, which are PDSCH 4, PDSCH 5 and PDSCH 6, respectively.

In addition or alternatively, in some embodiments, the slot for the data channel transmission in the other carriers may include the slots from the first slot that overlaps in the time domain with the slot of the reference data channel to the last slot that overlaps in the time domain with the reference data channel. To illustrate, still referring to FIG. 8, slot 0 of carrier 0 is the first slot overlapping with slot 0 of carrier 2 in the time domain. Slot 1 of carrier 0 is the last slot overlapping with PDSCH 1 in the time domain. Therefore, the plurality of PDSCHs are transmitted in slot 0 and slot 1 in carrier 0, which are PDSCH 2 and PDSCH 3, respectively. For carrier 1, slot 0 is the first slot overlapping with slot 0 of carrier 2 in the time domain. Slot 2 of carrier 1 is the last slot overlapping with PDSCH 1 in the time domain. Therefore, the plurality of PDSCHs are transmitted in slot 0, slot 1 and slot 2 in carrier 1, which are PDSCH 4, PDSCH 5 and PDSCH 6, respectively. Note, in this example, PDSCH 4, PDSCH 5 and PDSCH 6 are not illustrated in FIG. 8.

In addition or alternatively, in some embodiments, the network device may configure (or indicate) the number of repetitions in one carrier, such as via a DCI, a medium access control (MAC) control element (CE), or radio resource control (RRC) signaling. In such embodiments, the plurality of data channels may be ordered first according to the time domain and second according to the frequency domain. Correspondingly, the plurality of data channels may be first mapped to (or transmitted in) the reference carrier. Then, after the number of data channels mapped to a carrier is equal to the number of repetitions configured for the carrier, remaining unmapped data channels, if any, may be mapped to (or transmitted in) the next carriers, and so on, until the end of the plurality of data channels.

For the carriers other than the reference carrier, the plurality of data channel may be mapped to the slots starting from the first slot overlapping with the first reference PDSCH.

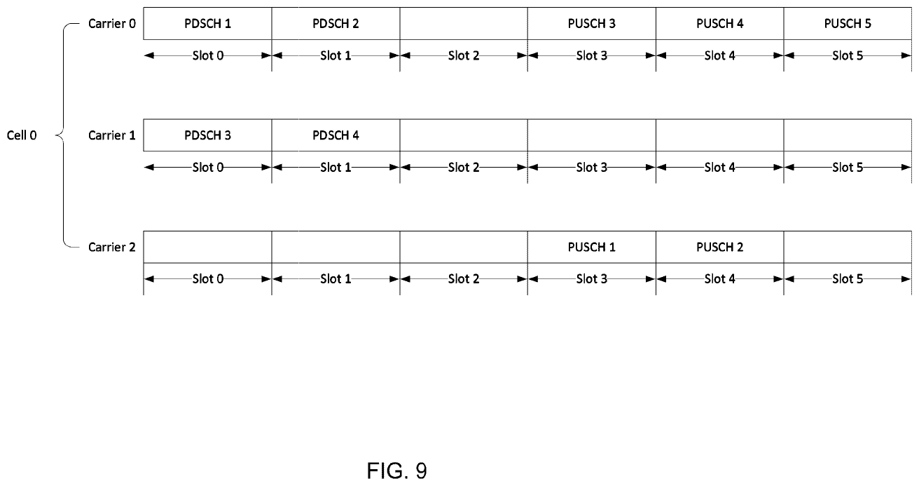

To illustrate, FIG. 9 is a schematic diagram showing an example of scheduling a plurality of PDSCHs and PUSCHs. For at least some of these embodiments, the network device 104 may indicate a certain number of repetitions for PDSCH, such as two in the example in FIG. 9. The indicated certain number may be for all carrier 0, carrier 1 and carrier 2. Also, the network device 104 may indicate the first PDSCH (e.g., PDSCH 1) is in slot 0 in carrier 0. Then, the first two PDSCHs (e.g., PDSCH 1 and PDSCH 2) are in slot 0 and slot 1 in carrier 0, respectively. The remaining PDSCHs are mapped to the next carrier (e.g., carrier 1). Also, the slot 0 in carrier 1 is the first slot overlapping with PDSCH 1. Then, the third PDSCH (e.g., PDSCH 3) and fourth PDSCH (e.g., PDSCH 4) are in slot 0 and slot 1 in carrier 1, respectively.

Also, in some embodiments, the network device 104 may indicate respective numbers of repetitions for each of the plurality of carriers. For example, with respect to FIG. 9, the network device 104 may indicate the number of repetitions for PUSCH to be 4, 2, 2 for carrier 0, carrier 1 and carrier 2, respectively. In addition, in the example, the network device 104 may indicate the first PUSCH (e.g., PUSCH 1) is in slot 3 in carrier 2 and the total number of repetitions for the PUSCH is five. In turn, the first two PUSCHs (e.g., PUSCH 1 and PUSCH 2) are in slot 3 and slot 4 in carrier 2, respectively. In event remaining PDSCHs are unmapped, such remaining PDSCHs may be mapped to a next carrier. To illustrate, in the example in FIG. 9, the remaining PDSCHs are mapped to the next carrier (e.g., carrier 0). The slot 3 in carrier 0 is the first slot overlapping with PUSCH 1. Correspondingly, the remaining three PUSCHs (e.g., PUSCH 3, PUSCH 4 and PUSCH 5) are in slot 3, slot 4 and slot 5 in carrier 0, respectively.

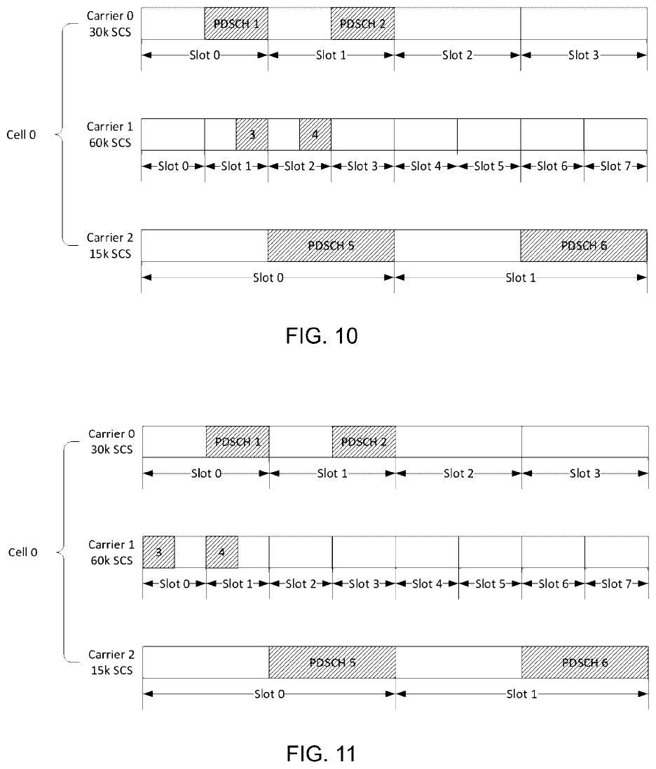

FIG. 10 is a schematic diagram illustrating another example of scheduling the plurality of PDSCHs. For some of these embodiments, the network device 104 may indicate a certain number of repetitions for the PDSCH for each of the carriers. For example, in FIG. 10, the network device may indicate that the number of repetitions for PDSCH is 2 for each of the carrier 0, carrier 1 and carrier 2. Also, in the example in FIG. 10, the network device 104 may indicate that the first PDSCH (e.g., PDSCH 1) is in slot 0 in carrier 0 and the total number of repetitions for PDSCH is six. Therefore, the first two PDSCHs (e.g., PDSCH 1 and PDSCH 2) are in slot 0 and slot 1 in carrier 0, respectively. Further, remaining unmapped PDSCHs are mapped to the next carrier (e.g., carrier 1). The slot 1 in carrier 1 is the first slot overlapping with PDSCH 1. Then, the third PDSCH (e.g., PDSCH 3) and fourth PDSCH (e.g., PDSCH 4) are in slot 1 and slot 2 in carrier 1, respectively. Similarly, the fifth PDSCH (e.g., PDSCH 5) and the sixth PDSCH (e.g., PDSCH 6) are in slot 0 and slot 1 in carrier 2, respectively since slot 0 in carrier 2 is the first slot overlapping with the PDSCH 1.

In some other embodiments, for the carriers other than the reference carrier, the plurality of data channels may be mapped to the slots starting from the first slot overlapping with the slot of the first reference PDSCH.

To illustrate, FIG. 11 provides another example of scheduling the plurality of PDSCHs. In the example in FIG. 11, in carrier 1, the slot 0 is the first slot overlapping with the slot of PDSCH 1 (e.g., slot 0 in carrier 0). Correspondingly, the third PDSCH (e.g., PDSCH 3) and fourth PDSCH (e.g., PDSCH 4) are in slot 0 and slot 1 in carrier 1, respectively. Similarly, the fifth PDSCH (e.g., PDSCH 5) and the sixth PDSCH (e.g., PDSCH 6) are in slot 0 and slot 1 in carrier 2, respectively since slot 0 in carrier 2 is the first slot overlapping with the slot of PDSCH 1 (e.g., slot 0 in carrier 0).

Also, in some embodiments, the network device 104 may indicate (or schedule) a plurality of nominal data channels. In some embodiments, such as accordance with NR specifications, when Type B repetition is configured, the time domain resource is indicated by the network device 104. The plurality of data channels may have the same time domain resource size and may be mapped to the symbols consecutively no matter whether the symbols are uplink and/or flexible symbols. These configured data channels are referred to as nominal data channels. The nominal data channels may be changed to actual data channels according to at least an invalid symbol or a slot boundary. In some embodiments, only the actual data channel may be transmitted between the network device 104 and the user device 102. Also, the invalid symbol may at least include a downlink symbol, a symbol used only for downlink transmission, or a symbol that cannot be used for uplink transmission. Additionally, for at least some embodiments, if there is no slot boundary or invalid symbol within a nominal data channel, then the nominal data channel is changed to an actual data channel. Within a nominal data channel, all the symbols except for the invalid symbols are valid symbols. Additionally, if there is at least a slot boundary or an invalid symbol within a nominal data channel, then the nominal data channel is split into more than one actual data channel. An actual data channel may only include consecutive valid symbols and may not extend across a slot boundary or an invalid symbol. These actual data channels are processed and transmitted separately.

In addition, for at least some embodiments, the network device 104 may indicate (or configure) the time domain resource of the first nominal data channel. The time domain resource may include the resource size (e.g., the number of OFDM symbols) and the resource location (e.g., the starting symbol of the data channel). The plurality of nominal data channel may have the same time domain resource size. The plurality of data channels may be mapped to a plurality of slots consecutively starting from the first nominal data channel. In some of these embodiments, there may be no gap between two consecutive data channels. If the available time domain resource of a slot cannot accommodate a nominal data channel, the nominal data channel may be across the slot and the next slot. When a nominal data channel is across the slot boundary, the nominal data channel may be split into two parts (or two actual data channels). The first part (or the first actual data channel) may be in the first slot and the second part (or the second actual data channel) may be in the second slot. The transport block may be mapped to the two parts separately (or two actual data channels). The two parts (or two actual data channels) may be transmitted separately.

Additionally, the plurality of slots may be in the one or more carriers of the serving cell. The plurality of slots may be ordered according to the frequency domain and/or the time domain.

In addition or alternatively, in some embodiments, the plurality of the slots may be ordered first according to the frequency domain, and second according to the time domain. In such embodiments, first, the plurality of nominal data channels may be mapped to the slot of the reference carrier. Second, if any remaining nominal data channels are unmapped, such remaining nominal data channels may be mapped to the slot of the next carrier, and so on. Third, after the plurality of nominal data channels are mapped to the slot of the last carrier, the remaining nominal data channels, if any, may be mapped to the next slot of the first carrier.

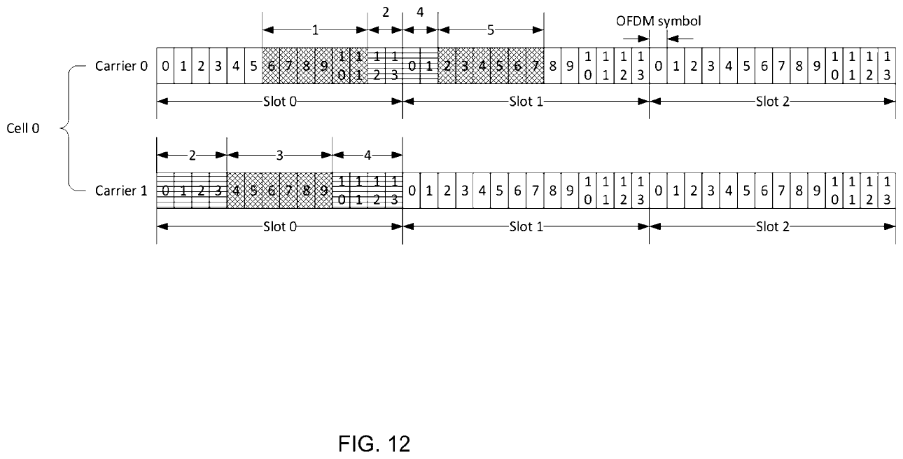

FIG. 12 is a schematic diagram illustrating another example of scheduling data channels. In the example, a slot includes 14 orthogonal frequency-division multiplexing (OFDM) symbols, denoted in FIG. 12 as symbols 0-13. In addition, in some embodiments of the example in FIG. 12, the network device 104 may indicate that the first nominal data channel is in the slot 0 in carrier 0, which may occupy six OFDM symbols starting from symbol 6 to symbol 11. In addition or alternatively, in the example in FIG. 12, the plurality of slots may be ordered first according to the frequency domain and second according to the time domain. Correspondingly, in FIG. 12, the order of the slots may be slot 0 of carrier 0, slot 0 of carrier 1, slot 1 of carrier 0, slot 1 of carrier 1, slot 2 of carrier 0, slot 2 of carrier 1, and so on. Therefore, the plurality of nominal data channels may be mapped to the slots according to such an order. Following the first nominal data channel, the second nominal data channel is mapped to symbol 12 and 13 of the slot 0 of carrier 0, and symbols 0-3 of slot 0 of carrier 1. Similarly, the third nominal data channel may be mapped to symbols 4-9 of the slot 0 of carrier 1. The fourth nominal data channel is mapped to symbols 10-13 of the slot 0 of carrier 1, and symbols 0-1 of slot 1 of carrier 0. The fifth nominal data channel may be mapped to symbols 2-7 of the slot 1 of carrier 0.

Additionally, still referring to FIG. 12, in some embodiments, the second nominal data channel may be split into two parts (or two actual data channels). The first part (or the first actual data channel) includes symbols 12 and 13 of the slot 0 of carrier 0, and the second part (or the second actual data channel) includes symbols 0-3 of slot 0 of carrier 1. The two parts (or two actual data channels) may be transmitted separately. Similarly, the fourth nominal data channel may be split into two parts (or two actual data channels). The first part (or the first actual data channel) includes symbols 10-13 of the slot 0 of carrier 1, and the second part (or the second actual data channel) includes symbols 0-1 of slot 1 of carrier 0. The two parts (or two actual data channels) may be transmitted separately. For the other nominal data channels, there is no split assuming there is no invalid symbol. It means one nominal data channel is one actual data channel.

In other embodiments, the plurality of nominal data channels may be mapped to the slot of all the carriers. After the plurality of nominal data channels are mapped to the slot of all the carriers, in event there are remaining unmapped nominal data channels, such remaining nominal data channels (if any) may be mapped to the next slot of the reference carrier.

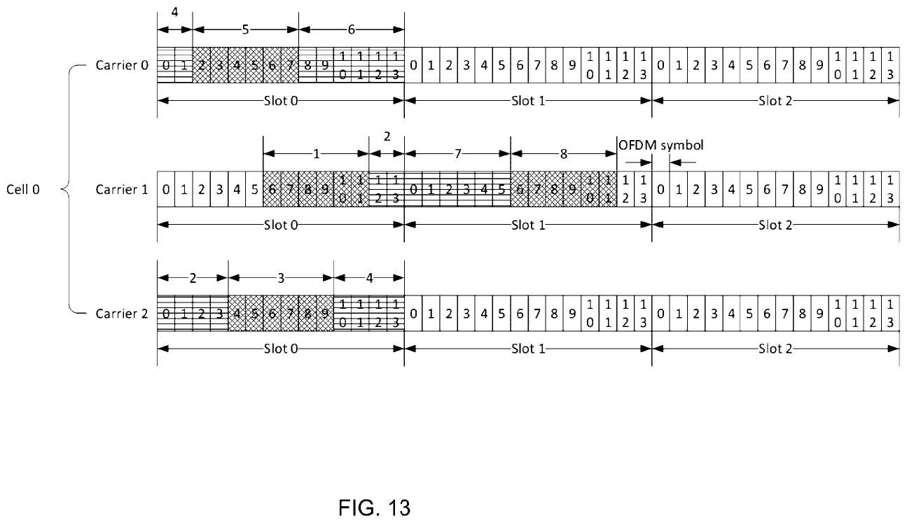

FIG. 13 is a schematic diagram illustrating another example of scheduling data channels. The network device 104 may indicate that the first nominal data channel is in the slot 0 in carrier 1, which may occupy six OFDM symbols starting from symbol 6 to symbol 11. In addition or alternatively, in the example in FIG. 13, the plurality of slots may be ordered first according to the frequency domain and second according to the time domain and the plurality of nominal data channels may be mapped to the slot of all the carriers. Correspondingly, in FIG. 13, the order of the slots may be slot 0 of carrier 1, slot 0 of carrier 2, slot 0 of carrier 0, slot 1 of carrier 1, slot 1 of carrier 2, slot 1 of carrier 0, and so on. Therefore, the plurality of nominal data channels may be mapped to the slots according to such an order. Following the first nominal data channel, the second nominal data channel is mapped to symbol 12 and 13 of the slot 0 of carrier 1, and symbols 0-3 of slot 0 of carrier 2. Similarly, the third nominal data channel may be mapped to symbols 4-9 of the slot 0 of carrier 2. The fourth nominal data channel is mapped to symbols 10-13 of the slot 0 of carrier 2, and symbols 0-1 of slot 0 of carrier 0. The fifth nominal data channel may be mapped to symbols 2-7 of the slot 0 of carrier 0. The symbols for the remaining nominal data channels (e.g., data channel 6-8) are illustrated in FIG. 13.

Similar to the example in FIG. 12, each of the nominal data channel 2 and nominal data channel 4 may be split into two parts (or two actual data channels).

In addition or alternatively, in some embodiments, the plurality of the slots may be ordered first according to the frequency domain, and second according to the time domain. For such embodiments, first, the plurality of nominal data channels may be mapped to the slot of the reference carrier. Second, in the event there are any remaining unmapped nominal data channels, such remaining nominal data channels (if any) may be mapped to the slot(s) of the next carrier that overlap with the first nominal data channel in the slot (or, any nominal data channels in the slot) in the reference carrier, and so on. That is to say, the remaining nominal data channel(s), if any, may be mapped to the slots of the next carrier starting from the first slot that overlaps with the first nominal data channel in the slot (or, any nominal data channels in the slot) in the reference carrier to the last slot that overlaps with the first nominal data channel in the slot (or, any nominal data channels in the slot) in the reference carrier, and so on. Third, after the plurality of nominal data channels are mapped to the slot of the last carrier, in event there are still remaining unmapped nominal data channels, such remaining nominal data channels (if any) may be mapped to the next slot of the first carrier. Alternatively, after the plurality of nominal data channels are mapped to the slot of all the carriers, the remaining nominal data channels, if any, may be mapped to the next slot of the reference carrier.

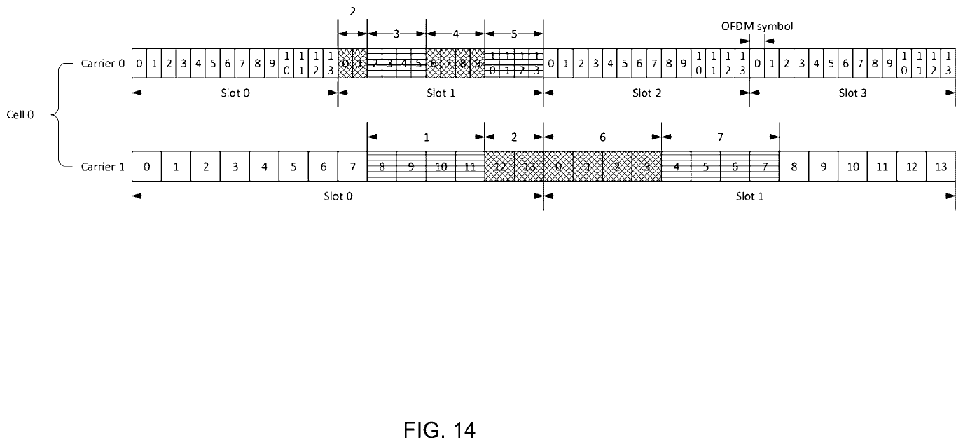

FIG. 14 is a schematic diagram illustrating another example of scheduling data channels. Two slots of carrier 0 correspond to one slot of carrier 1. The network device 104 may indicate that the first nominal data channel is in the slot 0 in carrier 1, which may occupy 4 OFDM symbols starting from symbol 8 to symbol 11. Correspondingly, the order of the slots may be slot 0 of carrier 1, slot 1 of carrier 0 (the slot in carrier 0 overlapping with the first nominal data channel), slot 1 of carrier 1, slot 2 of carrier 0 (the slot in carrier 0 overlapping with the first nominal data channel in slot in carrier 1), and so on. Therefore, the plurality of nominal data channels may be mapped to the slots according to such an order. Following the first nominal data channel, the second nominal data channel is mapped to symbol 12 and 13 of the slot 0 of carrier 1, and symbols 0-1 of slot 1 of carrier 0. Similarly, the third, fourth, and fifth nominal data channels may be mapped to symbols 2-5, symbols 6-9, and symbols 10-13 of the slot 1 of carrier 0, respectively. The symbols for the remaining nominal data channels (e.g., data channel 6-7) are illustrated in FIG. 14.

Similar to the example in FIG. 12, the second nominal data channel may be split into two parts (or two actual data channels).

In addition or alternatively, in some embodiments, the plurality of the slots may be ordered first according to the frequency domain, and second according to the time domain. In such embodiments, first, the plurality of nominal data channels may be mapped to the slot of the reference carrier. Second, in event there are remaining unmapped nominal data channels, such remaining nominal data channels (if any) may be mapped to the slot(s) of the next carrier that overlap with the slot of the nominal data channel in the reference carrier, and so on. That is to say, the remaining nominal data channel, if any, may be mapped to the slots of the next carrier starting from the first slot that overlaps with the slot of nominal data channels in the reference carrier to the last slot that overlaps with the slot of the nominal data channel in the reference carrier, and so on. Third, after the plurality of nominal data channels are mapped to the slot of the last carrier, the remaining unmapped nominal data channels, if any, may be mapped to the next slot of the first carrier. Alternatively, after the plurality of nominal data channels are mapped to the slot of all the carriers, remaining unmapped nominal data channels, if any, may be mapped to the next slot of the reference carrier.

To illustrate, still referring to FIG. 14, the order of the slots may be slot 0 of carrier 1, slot 0 of carrier 0, slot 1 of carrier 0 (since slot 0 of carrier 0 and slot 1 of carrier 0 overlaps with the slot 0 of carrier 1), slot 1 of carrier 1, slot 2 of carrier 0, and slot 3 of carrier 0 (since slot 2 of carrier 0, and slot 3 of carrier 0 overlaps with the slot 1 of carrier 1), and so on. Therefore, the plurality of nominal data channels may be mapped to the slots according to such an order. Following the first nominal data channel, the second nominal data channel is mapped to symbols 12 and 13 of the slot 0 of carrier 1, and symbols 0-1 of slot 0 of carrier 0. Similarly, the third, fourth, and fifth nominal data channels may be mapped to symbols 2-5, symbols 6-9, and symbols 10-13 of the slot 0 of carrier 0, respectively. The symbols for the remaining nominal data channels are shown in Table 1. Note, in this example, nominal data channels 2-10 are not illustrated in FIG. 14.

TABLE 1

| Nominal data channel | Occupied symbols |
|---|---|
| Nominal data channel 1 | Symbol#8, #9, #10, #11 of slot 0 in carrier 1 |
| Nominal data channel 2 | Symbol#12, #13 of slot 0 in carrier 1, symbol |
| | #0, #1 of slot 0 in carrier 0 |
| Nominal data channel 3 | Symbol#2, #3, #4, #5 of slot 0 in carrier 0 |
| Nominal data channel 4 | Symbol#6, #7, #8, #9 of slot 0 in carrier 0 |
| Nominal data channel 5 | Symbol#10, #11, #12, #13 of slot 0 in carrier 0 |
| Nominal data channel 6 | Symbol#0, #1, #2, #3 of slot 1 in carrier 0 |
| Nominal data channel 7 | Symbol#4, #5, #6, #7 of slot 1 in carrier 0 |
| Nominal data channel 8 | Symbol#8, #9, #10, #11 of slot 1 in carrier 0 |
| Nominal data channel 9 | Symbol#12, #13 of slot 1 in carrier 0, symbol |
| | #0, #1 of slot 1 in carrier 1 |
| Nominal data channel | Symbol#2, #3, #4, #5 of slot 1 in carrier 1 |
| 10 | |

Similar to the example in FIG. 12, the nominal data channels across the slot boundary (e.g., nominal data channel 2 and 9) may be split into two parts (or two actual data channels).

In addition or alternatively, in some embodiments, the plurality of the slots may be ordered first according to the frequency domain and second according to the time domain. First, the plurality of nominal data channels may be mapped to the slot of the reference carrier. Second, remaining unmapped nominal data channels, if any, may be mapped to the slots of the next carrier starting from the first slot that overlaps with the slot of the nominal data channel in the slot in the reference carrier to the last slot that overlaps with the first nominal data channel in the slot (or, any nominal data channels in the slot) in the reference carrier, and so on. Third, after the plurality of nominal data channels are mapped to the slot of the last carrier, the remaining nominal data channels, if any, may be mapped to the next slot of the first carrier. Alternatively, after the plurality of nominal data channels are mapped to the slot of all of the carriers, the remaining nominal data channels, if any, may be mapped to the next slot of the reference carrier.

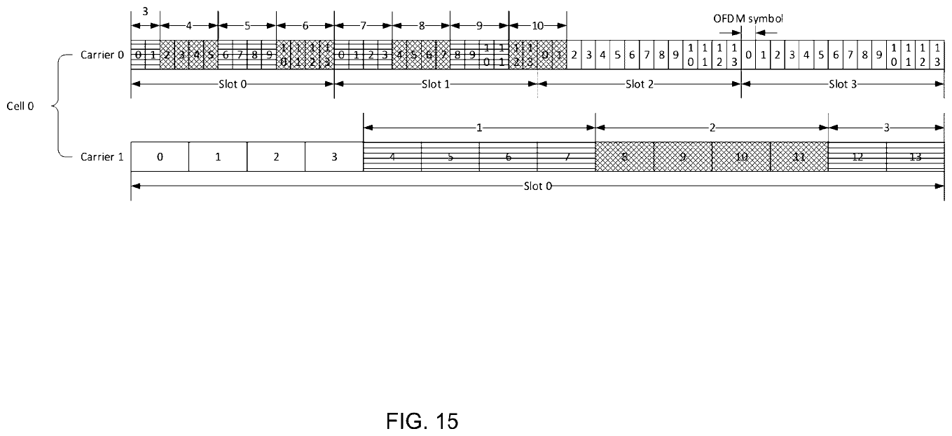

FIG. 15 is a schematic diagram illustrating another example of scheduling data channels. Four slots of carrier 0 correspond to one slot of carrier 1. The network device 104 may indicate that the first nominal data channel is in the slot 0 in carrier 1, which may occupy 4 OFDM symbols starting from symbol 4 to symbol 7. Correspondingly, the order of the slots may be slot 0 of carrier 1, slot 0 of carrier 0 (the first slot in carrier 0 overlapping with the slot 0 of carrier 1), slot 1 of carrier 0, slot 2 of carrier 0 (the last slot in carrier 0 overlapping with the first nominal data channel), slot 1 of carrier 1, slot 4 of carrier 0, slot 5 of carrier 0, slot 6 of carrier 0, and so on. Therefore, the plurality of nominal data channels may be mapped to the slots according to such an order. Following the first nominal data channel, the second nominal data channel is mapped to symbols 8-11 of the slot 0 of carrier 1. The third nominal data channel is mapped to symbol 12 and 13 of slot 0 in carrier 1, and symbol 0 and 1 of slot 0 of carrier 0. The symbols for the remaining nominal data channels (e.g., data channel 4-10) are illustrated in FIG. 15.

Similar to the example in FIG. 12, the nominal data channel across the slot boundary (e.g., nominal data channel 3 and 10) may be split into two parts (or two actual data channels).

In addition or alternatively, in some embodiments, the plurality of the slots may be ordered first according to the frequency domain and second according to the time domain. First, the plurality of nominal data channels may be mapped to the slot of the reference carrier. Second, remaining unmapped nominal data channels, if any, may be mapped to the slots of the next carrier starting from the first slot that overlaps with the first nominal data channel in the slot (or, any nominal data channels in the slot) in the reference carrier to the last slot that overlaps with the slot of the nominal data channel in the reference carrier, and so on. Third, after the plurality of nominal data channels are mapped to the slot of the last carrier, the remaining nominal data channels, if any, may be mapped to the next slot of the first carrier. Alternatively, after the plurality of nominal data channels are mapped to the slot of all of the carriers, the remaining nominal data channels, if any, may be mapped to the next slot of the reference carrier.

To illustrate, still referring to FIG. 15, the order of the slots may be slot 0 of carrier 1, slot 1 of carrier 0 (the first slot in carrier 0 overlapping with the first nominal data channel in slot 0 in carrier 1), slot 2 of carrier 0, slot 3 of carrier 0 (the last slot in carrier 0 overlapping with the slot 0 in carrier 1), slot 1 of carrier 1, slot 5 of carrier 0, slot 6 of carrier 0, slot 7 of carrier 0, and so on. Therefore, the plurality of nominal data channels may be mapped to the slots according to such an order. Following the first nominal data channel, the second nominal data channel is mapped to symbols 8-11 of the slot 0 of carrier 1. The third nominal data channel is mapped to symbol 12 and 13 of slot 0 in carrier 1, and symbol 0 and 1 of slot 1 of carrier 0. The symbols for the remaining nominal data channels are shown in Table 2. Note, in this example, nominal data channels 3-14 are not illustrated in FIG. 15.

TABLE 2

| Nominal data channel | Occupied symbols |
|---|---|
| Nominal data channel 1 | Symbol#4, #5, #6, #7 of slot 0 in carrier 1 |
| Nominal data channel 2 | Symbol#8, #9, #10, #11 of slot 0 in carrier 1 |
| Nominal data channel 3 | Symbol#12, #13 of slot 0 in carrier 1, symbol |
| | #0, #1 of slot 1 in carrier 0 |
| Nominal data channel 4 | Symbol#2, #3, #4, #5 of slot 1 in carrier 0 |
| Nominal data channel 5 | Symbol#6, #7, #8, #9 of slot 1 in carrier 0 |
| Nominal data channel 6 | Symbol#10, #11, #12, #13 of slot 1 in carrier 0 |
| Nominal data channel 7 | Symbol#0, #1, #2, #3 of slot 2 in carrier 0 |
| Nominal data channel 8 | Symbol#4, #5, #6, #7 of slot 2 in carrier 0 |
| Nominal data channel 9 | Symbol#8, #9, #10, #11 of slot 2 in carrier 0 |
| Nominal data channel | Symbol#12, #13 of slot 2 in carrier 0, symbol |
| 10 | #0, #1 of slot 3 in carrier 0 |
| Nominal data channel | Symbol#2, #3, #4, #5 of slot 3 in carrier 0 |
| 11 | |
| Nominal data channel | Symbol#6, #7, #8, #9 of slot 3 in carrier 0 |
| 12 | |
| Nominal data channel | Symbol#10, #11, #12, #13 of slot 3 in carrier 0 |
| 13 | |
| Nominal data channel | Symbol#0, #1, #2, #3 of slot 1 in carrier 1 |
| 14 | |

Similar to the example in FIG. 12, the nominal data channel across the slot boundary (e.g., nominal data channels 3 and 10) may be split into two parts (or two actual data channels).

In addition or alternatively, in some embodiments, the plurality of the slots may be ordered first according to the time domain and second according to the frequency domain. First, the plurality of nominal data channels may be mapped to the slot of the reference carrier until the number of mapped nominal data channels is equal to the number configured by the network device 104 or until the end of the of the nominal data channels. Second, the remaining of the plurality of nominal data channels, if any, may be mapped to the next carrier starting from the first slot that overlaps with the first nominal data channel (or, any nominal data channels) in the reference carrier, and so on.

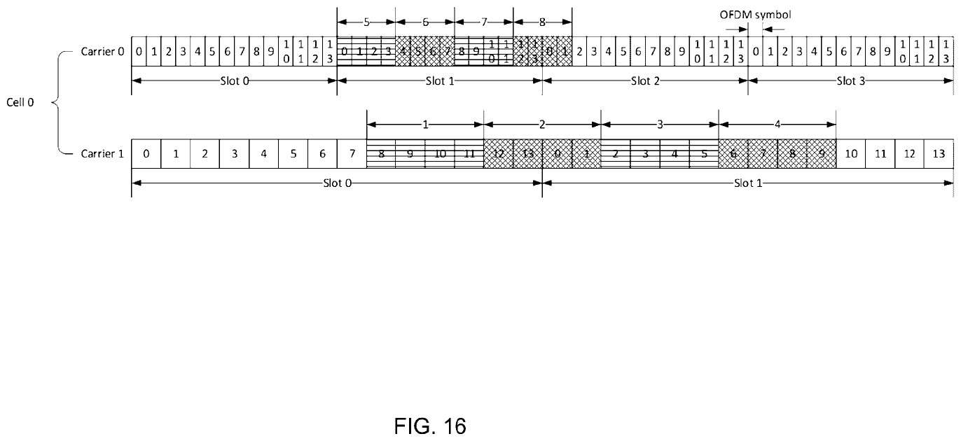

FIG. 16 is a schematic diagram illustrating another example of scheduling data channels. Two slots of carrier 0 correspond to one slot of carrier 1. The network device 104 may configure that number of repetitions is 4 for both carrier 0 and carrier 1. The network device 104 may indicate that the first nominal data channel is in the slot 0 in carrier 1, which may occupy 4 OFDM symbols starting from symbol 8 to symbol 11. Following the first nominal data channel, the second, the third and the fourth nominal data channels may occupy the subsequent symbols, which are illustrated in FIG. 16. In carrier 0, slot 1 is the first slot overlapping with the first nominal data channel in carrier 1. Therefore, the nominal data channels mapped to the carrier 0 may start from slot 1. The fifth nominal data channel may occupy symbols 0-3 of slot 1 in carrier 0. The sixth, seventh, and eighth nominal data channels may occupy the subsequent symbols in carrier 0, which are illustrated in FIG. 16.

Similar to the example in FIG. 12, the nominal data channel across the slot boundary (e.g., nominal data channels 2 and 8) may be split into two parts (or two actual data channels).

In addition or alternatively, in some embodiments, the plurality of the slots may be ordered first according to the time domain and second according to the frequency domain. First, the plurality of nominal data channels may be mapped to the slot of the reference carrier until the number of mapped nominal data channels is equal to the number configured by the network device 104 or until the end of the of the nominal data channels. Second, the remaining of the plurality of nominal data channels, if any, may be mapped to the next carrier starting from the first slot that overlaps with the slot of the first nominal data channel (or, any nominal data channel) in the reference carrier, and so on.

To illustrate, still referring to FIG. 16, slot 0 in carrier 0 is the first slot overlapping with the slot of the first nominal data channel in carrier 1. Therefore, the nominal data channels mapped to the carrier 0 may start from slot 0. The fifth nominal data channel may occupy symbols 0-3 of slot 0 in carrier 0. The sixth, seventh, and eighth nominal data channels may occupy the subsequent symbols in carrier 0 (e.g., symbols 4-7 of slot 0, symbols 8-11 of slot 0, symbols 12-13 of slot 0 and symbols 0-1 of slot 1, respectively).

Similar to the example in FIG. 12, the nominal data channel across the slot boundary (e.g., nominal data channel 2 and 8) may be split into two parts (or two actual data channels).

In addition or alternatively, in some embodiments, the plurality of the slots may be ordered first according to the time domain and second according to the frequency domain. First, the plurality of nominal data channels may be mapped to the slot of the reference carrier until the number of mapped nominal data channels is equal to the number configured by the network device 104 or until the end of the of the nominal data channels. Second, the remaining of the plurality of nominal data channels, if any, may be mapped to the next carrier starting from the first slot after the first nominal data channel (or, any nominal data channel) in the reference carrier, and so on.

To illustrate, still referring to FIG. 16, slot 2 in carrier 0 is the first slot after the first nominal data channel in carrier 1. Therefore, the nominal data channels mapped to the carrier 0 may start from slot 2. The fifth nominal data channel may occupy symbols 0-3 of slot 2 in carrier 0. The sixth, seventh, and eighth nominal data channels may occupy the subsequent symbols in carrier 0 (e.g., symbols 4-7 of slot 2, symbols 8-11 of slot 2, symbols 11-12 of slot 2 and symbols 0-1 of slot 3, respectively).

Similar to the example in FIG. 12, the nominal data channel across the slot boundary (e.g., nominal data channels 2 and 8) may be split into two parts (or two actual data channels).

In addition or alternatively, the slot in the plurality of carriers other than the reference carrier for the plurality of data channels mapping may be determined by the data channel or the slot in a previous carrier in accordance with the above embodiments. For example, the slot in carrier A for the plurality of data channels mapping may be determined by the data channel or the slot in carrier A−1 (or carrier A+1) in accordance with the above embodiments.

In a second scheduling process, control information (e.g., a DCI) may schedule only one data channel. In such embodiments, one or more sets of control information (e.g., one or more DCIs) may respectively schedule the one or more data channels. For example, a first DCI may schedule a first data channel, a second DCI may schedule a second data channel, and so on. In some of these embodiments, the network device 104 may indicate that the plurality of data channels may carry the same transport block(s).

Additionally, in some embodiments, a plurality of sets of control information (e.g., a plurality of DCIs) may include the same new data indicator (NDI). When the user device 102 receives a DCI scheduling a data channel, the user device 102 may compare a first NDI value in the DCI with a second NDI value included in a previous DCI. In some of these embodiments, the user device 102 may determine that the data channel is a retransmission when the NDI value is not toggled.

Additionally, in some embodiments, sets of control information (e.g., the DCIs) scheduling a plurality of PDSCHs may have the same counter downlink assignment indication (DAI) value. In particular of these embodiments, the DCIs transmitted in the same PDCCH monitoring occasion may schedule some of the plurality of PDSCHs. These DCIs may include the same counter DAI value. In this case, the user device 102 may generate the same HARQ-ACK information bit for the plurality of PDSCHs. For example, the user device 102 may generate a HARQ-ACK information bit for the plurality of PDSCHs. Alternatively, the user device 102 may generate more than one HARQ-ACK information bits for the plurality of PDSCHs, where the number of HARQ-ACK information bits may be equal to the total number of the transport blocks or code block groups for the data channel.

In addition, in some embodiments, the serving cell may correspond to multiple HARQ entities. In at least some of these embodiments, the control information (e.g., DCI) may include the carrier index of the initial transmission of the transport block, i.e., in which carrier the initial transmission of the transmission block is transmitted. In addition, the control information (e.g., DCI) may indicate the HARQ process number (HPN) of the initial transmission of the transport block. For example, the initial transmission of a transport block is transmitted in carrier 0 and the corresponding HPN is 3. Then, a first field in the DCI that schedules the retransmission of the transport block may indicate the carrier 0. A second field in the DCI that schedules the retransmission of the transport block may indicate the HPN 3.

In addition or alternatively, in a third scheduling process, control information (e.g., a DCI) may schedule a plurality of data channels. The control information (e.g., DCI) may indicate the time domain resource and/or the frequency resource for each of the plurality of data channels. For at least some of these embodiments, the plurality of data channels may carry the same transport block. The control information (e.g., DCI) may include only one NDI field indicating the NDI value. The NDI field and/or value may be used to determine the plurality of data channels carrying a new transport block or a retransmitted transport block. Also, in some embodiments, the control information (e.g., DCI) may indicate a modulation and encoding scheme (MCS). In particular of these embodiments, the transport block size may be determined according the resource of the first data channel and the indicated MCS together.

In addition or alternatively, in some embodiments, for the data channels other than the first data channel, the DCI may only indicate the modulation order. The modulation order may include at least one of πT/2-binary phase-shift keying (BPSK), BPSK, quadrature phase-shift keying (QPSK), 16 quadrature amplitude modulation (QAM), 64QAM, 256QAM, or 1024QAM. For each of the data channels, other than the first data channel, the transport blocks may be processed with the indicated modulation order. For example, the DCI may indicate the MCS for the first data channel of the plurality of data channels and indicate the modulation order for the remaining data channels. In other embodiments, the plurality of data channels may carry more than one transport block. In some of these embodiments, the network device 104 may configure the number of repetitions to be Z, and the number of plurality of data channels scheduled by the network device 104 to be Y. For such embodiments, the total number of transport blocks carried by the plurality of data channels may be [Y/Z]*X, where X is the number of transport block that a data channel can carry. In particular of these embodiments, the first Z data channels may carry the same transport block (e.g., the first X transport blocks), and the second Z data channels may carry the same transport block (e.g., the second X transport block), and so on. Also, the last mod (Y,Z) data channels may carry the same transport block (e.g., the last X transport blocks). In this case, the network may indicate [Y/Z]*X MCS for the first data channel for each transport blocks. For the other data channels, the DCI may only indicate the modulation order. For example, the network device 104 may configure that the number of repetitions is 4 and the number of plurality of data channels is 10. Each data channel may carry only one transport block. The network device may schedule 10 data channels, denoted by data channels 1-10, respectively. The first 4 data channels (e.g., data channels 1-4) may carry the first transport block. The second 4 data channels (e.g., data channels 5-8) may carry the second transport block. The last 2 data channels (e.g., data channels 9-10) may carry the third transport block. The DCI may indicate the MCS for the data channel 1, data channel 5, and data channel 9, respectively. The DCI may indicate the modulation order for the remaining data channels, respectively.

In addition or alternatively, in some embodiments, the HARQ-acknowledgement (ACK) information corresponding to the control information (e.g., DCI) (or the plurality of data channels) may include [Y/Z]*X bits in the case of transport block (TB)-based feedback, where each bit may correspond to a transport block. For code block group (CBG)-based feedback, the HARQ-ACK information bits corresponding to the control information (e.g., DCI) (or the plurality of data channels) may include [Y/Z]*X*G bits, where G is the maximum number of code block groups of a transport block and each bit may correspond to a code block group.

In addition or alternatively, in some embodiments, the network device 104 may schedule a plurality of data channels in accordance with the above embodiments. The plurality of data channels may carry only one transport block. In some of these embodiments, the transport block size of the only one transport block may be determined according to the total resource size of the plurality of data channels. The total resource size may be the sum of the available resource elements (RE) of the plurality of data channels for data mapping. Alternatively, the total resource size may be the available REs of the first data channel multiplied by the number or repetitions (e.g., Z).

In addition, in some of these embodiments, the modulated symbols may be mapped to the RE of the plurality of data channels carrier-by-carrier. In other words, the modulated symbols are mapped to the resource element, first in the order of sub-carrier index, second in the order of the symbol index, and third in the order of carrier index. Alternatively, the modulated symbols are mapped to the resource element, first in the order of sub-carrier index, second in the order of the carrier index, and third in the order of the symbol index.

During the bit selection procedure for a data channel, the bits for the first data channel may be selected from the circular buffer starting from a bit determined by the redundant version (RV). Also, the bits for the subsequent data channels may be selected from the circular buffer by following the last bit for the previous data channel. Assuming that the last bit for a data channel is by, then the first bit for the next data channel is b_{N+1}. In some embodiments, the bit selection for the data channels may be performed by assuming that there is no UCI multiplexed in the plurality of data channels.

In addition or alternatively, in some embodiments, the network device 104 may configure a plurality of serving cells (e.g., one or more serving cells) for a user device 102. In some of these embodiments, the plurality of serving cells may be operated in terms of carrier aggregation (CA). In addition or alternatively, the network device 104 may schedule a plurality of data channels via DCI, MAC, or RRC signaling. The plurality of data channels may be transmitted on the plurality of serving cells. The plurality of data channels may be scheduled in accordance with the above embodiments by replacing a carrier with a serving cell.

Also, in some embodiments, control information (e.g., a DCI) may schedule a plurality of data channels on the plurality of the serving cell. The plurality of data channels may carry the same transport block(s). The data channels (or transport block(s)) may be transmitted repeatedly. The first data channel may be referred to as the first repetition. The second data channel may be referred to as the second repetition, and so on. The network device 104 may indicate the serving cell (e.g., the cell index) of the first data channel. The indicated cell may be referred to as the reference cell. The data channel transmitted on the reference cell may be referred to as reference data channel.

For at least some of these embodiments, for a data channel transmitted in a slot in a cell, the next data channel may be transmitted in the next slot and/or in the next cell. In addition or alternatively, the plurality of data channels may be ordered first according to the frequency domain (e.g., cell index), and second according to the time domain (e.g., slot index). The plurality of data channels may be first mapped to (or transmitted in) the plurality of serving cell in a slot in accordance with the embodiments. In some embodiments, the mapping may start from the cell indicated by the network device via DCI or RRC signaling. After the plurality of the data channels are mapped (or transmitted) in the last cell in a slot, then the remaining data channels, if any, may be mapped to (or transmitted in) the cells in the next slot, and so on. The first data channel in the next slot may be in the cell with the smallest cell index or the largest cell index, depending on the mapping order. For implementations where the ascending order of the cell index is used, the first data channel in the next slot may be in the cell with the smallest cell index. For implementations where the descending order of the cell index is used, the first data channel in the next slot may be in the cell with the largest cell index. In other embodiments, after the plurality of the data channels are mapped to (or transmitted in) all of the of serving cells in a slot, then the remaining data channels, if any, may be mapped to (or transmitted in) the cell in the next slot, and so on. In some of these other embodiments, the first data channel in the next slot may be in the cell indicated by the network device 104.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: transmitting, by a network device, control information to schedule a plurality of data channels transmitted in a plurality of carriers, wherein the control information indicates a resource of the plurality of data channels, and the plurality of data channels are ordered according to an order determined by at least one of a frequency domain or a time domain; and communicating, by the network device, the plurality of data channels in the plurality of carriers according to the resource and the order.

A second aspect includes a method for wireless communication that includes: receiving, by a user device, control information to schedule a plurality of data channels transmitted in a plurality of carriers, wherein the control information indicates a resource of plurality of data channels, and the plurality of data channels are ordered according to an order determined by at least one of a frequency domain or a time domain; and communicating, by the user device, the plurality of data channels in the plurality of carriers according to the resource and the order.

A third aspect includes any of the first or second aspects, and further includes wherein the resource of the plurality of data channels comprises a resource of a first data channel of the plurality of data channels.

A fourth aspect includes any of the first through third aspects, and further includes wherein the plurality of carriers belong to a serving cell.

A fifth aspect includes any of the first through fourth aspects, and wherein the plurality of data channels are ordered first according to the time domain, and second according to the frequency domain.

A sixth aspect includes the fifth aspect, and further includes wherein the plurality of data channels are mapped to slots of an initial carrier indicated by the network device according to a slot index until a number the plurality of data channels that are mapped is equal to a value configured by the network device or until a last of the plurality of data channels is mapped.

A seventh aspect includes the sixth aspect, and further includes wherein a set of one or more remaining data channels is unmapped to the slots of the initial carrier when the number of the plurality of data channels that are mapped is equal to the value, and the set is mapped to a next carrier starting from a first slot or a last slot that overlaps with a data channel transmitted in the plurality of carriers indicated by the network device or that overlaps with a slot of a data channel transmitted in the plurality of carriers indicated by the network device.

An eighth aspect includes any of the first through fourth aspects, and further includes wherein the plurality of data channels are ordered first according to the frequency domain, and second according to the time domain.

A ninth aspect includes the eighth aspect, and further includes wherein the plurality of data channels are mapped to the plurality of carriers in a slot.

A tenth aspect includes the ninth aspect, and further includes wherein the slot is in the plurality of carriers other than a carrier indicated by the network device for the transmission of the plurality of data channels, and wherein the slot includes at least one of the slots from a first slot to a last slot, wherein the first slot or the last slot overlaps with a data channel transmitted in the plurality of carriers indicated by the network device or overlaps with a slot of the data channel transmitted in the plurality of carriers indicated by the network device.

An eleventh aspect includes the tenth aspect, and further includes wherein a set of one or more remaining data channels is unmapped after the plurality of data channels are mapped to a last carrier in the slot, and the set is mapped to the plurality of carriers starting from a next slot of a first carrier of the plurality of carriers.

A twelfth aspect includes the tenth aspect, and further includes wherein a set of one or more remaining data channels is unmapped after the plurality of data channels are mapped to all carriers in the slot, and the set is mapped to the plurality of carriers starting from a next slot of a carrier of the plurality of carriers indicated by the network device.

A thirteenth aspect includes any of the first through fourth aspects, and further includes wherein the resource comprises a time domain resource, the network device indicates the time domain resource of a first data channel of the plurality of data channels, and the plurality of data channels are mapped to a plurality of slots consecutively starting from the first data channel.

A fourteenth aspect includes the thirteenth aspect, and further includes wherein the plurality of slots are in the plurality of carriers and ordered first according to the frequency domain, and second according to the time domain.

A fifteenth aspect includes the fourteenth aspect, and further includes wherein the slot of the plurality of slots in the plurality of carriers other than a carrier indicated by the network device includes at least one of the slots from a first slot to a last slot, wherein the first slot or the last slot overlaps with a data channel transmitted in the plurality of carriers indicated by the network device or overlaps with a slot of the data channel transmitted in the plurality of carriers indicated by the network device.

A sixteenth aspect includes the thirteenth aspect, and further includes wherein the plurality of slots are in the plurality of carriers and ordered first according to the time domain, and second according to the frequency domain.

A seventeenth aspect includes the sixteenth aspect, and further includes wherein the slot of the plurality of slots in the plurality of carriers other than a carrier indicated by the network device starts from a first slot or a last slot that overlaps with a data channel transmitted in the plurality of carriers indicated by the network device or that overlaps with a slot of the data channel transmitted in the plurality of carriers indicated by the network device.

An eighteenth aspect includes the thirteenth aspect, and further includes wherein a data channel that is mapped to two slots consecutively is split into two parts, wherein a first part is within a first slot and a second part is within a second slot, and the two parts are transmitted separately.

A nineteenth aspect includes any of the first through nineteenth aspects, and further includes wherein a transport block carried in the plurality of data channels is determined by a total resource size of the plurality of data channels.

A twentieth aspect includes the nineteenth aspect, and further includes wherein a set of bits for a plurality of subsequent data channels is selected from a circular buffer by following a last bit for a previous data channel of the plurality of data channels.

A twenty-first aspect includes any of the first through twentieth aspects, and further includes wherein the plurality of data channels includes at least one of a physical downlink shared channel, a physical uplink shared channel, or a physical sidelink shared channel, and the control information includes at least one of downlink control information, sidelink control information, a medium access control-control element, or radio resource control signaling.

A twenty-second aspect includes a wireless communications apparatus comprising a processor and a memory, wherein the processor is configured to read code from the memory to implement any of the first through twenty-first aspects.

A twenty-third aspect includes a computer program product comprising a computer-readable program medium comprising code stored thereupon, the code, when executed by a processor, causing the processor to implement any of the first through twenty-first aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
transmitting, by a network device, control information to schedule a plurality of data channels transmitted in a plurality of carriers, wherein the control information indicates a resource of the plurality of data channels, and the plurality of data channels are ordered according to an order determined by at least one of a frequency domain or a time domain; and
communicating, by the network device, the plurality of data channels in the plurality of carriers according to the resource and the order.

2. A method for wireless communication, the method comprising:
receiving, by a user device, control information to schedule a plurality of data channels transmitted in a plurality of carriers, wherein the control information indicates a resource of plurality of data channels, and the plurality of data channels are ordered according to an order determined by at least one of a frequency domain or a time domain; and
communicating, by the user device, the plurality of data channels in the plurality of carriers according to the resource and the order.

3. The method of claim 2, wherein the resource of the plurality of data channels comprises a resource of a first data channel of the plurality of data channels.

4. The method of claim 2, wherein the plurality of carriers belong to a serving cell.

5. The method of claim 2, wherein the plurality of data channels are ordered first according to the time domain, and second according to the frequency domain.

6. The method of claim 5, wherein the plurality of data channels are mapped to slots of an initial carrier indicated by a network device according to a slot index until a number the plurality of data channels that are mapped is equal to a value configured by the network device or until a last of the plurality of data channels is mapped.

7. The method of claim 6, wherein a set of one or more remaining data channels is unmapped to the slots of the initial carrier when the number of the plurality of data channels that are mapped is equal to the value, the set is mapped to a next carrier starting from a first slot or a last slot that overlaps with a data channel transmitted in the plurality of carriers indicated by the network device or that overlaps with a slot of a data channel transmitted in the plurality of carriers indicated by the network device.

8. The method of claim 2, wherein the plurality of data channels are ordered first according to the frequency domain, and second according to the time domain.

9. The method of claim 8, wherein the plurality of data channels are mapped to the plurality of carriers in a slot.

10. The method of claim 9, wherein the slot is in the plurality of carriers other than a carrier indicated by a network device for the transmission of the plurality of data channels, and wherein the slot includes at least one of the slots from a first slot to a last slot, wherein the first slot or the last slot overlaps with a data channel transmitted in the plurality of carriers indicated by the network device or overlaps with a slot of the data channel transmitted in the plurality of carriers indicated by the network device.

11. The method of claim 10, wherein a set of one or more remaining data channels is unmapped after the plurality of data channels are mapped to a last carrier in the slot, the set is mapped to the plurality of carriers starting from a next slot of a first carrier of the plurality of carriers.

12. The method of claim 10, wherein a set of one or more remaining data channels is unmapped after the plurality of data channels are mapped to all carriers in the slot, the set is mapped to the plurality of carriers starting from a next slot of a carrier of the plurality of carriers indicated by the network device.

13. The method of claim 2, wherein the resource comprises a time domain resource, the time domain resource of a first data channel of the plurality of data channels is indicated by a network device, and the plurality of data channels are mapped to a plurality of slots consecutively starting from the first data channel.

14. The method of claim 13, wherein the plurality of slots are in the plurality of carriers and ordered first according to the frequency domain, and second according to the time domain.

15. The method of claim 14, wherein the slot of the plurality of slots in the plurality of carriers other than a carrier indicated by a network device includes at least one of the slots from a first slot to a last slot, wherein the first slot or the last slot overlaps with a data channel transmitted in the plurality of carriers indicated by the network device or overlaps with a slot of the data channel transmitted in the plurality of carriers indicated by the network device.

16. The method of claim 13, wherein the plurality of slots are in the plurality of carriers and ordered first according to the time domain, and second according to the frequency domain, the slot of the plurality of slots in the plurality of carriers other than a carrier indicated by the network device starts from a first slot or a last slot that overlaps with a data channel transmitted in the plurality of carriers indicated by the network device or that overlaps with a slot of the data channel transmitted in the plurality of carriers indicated by the network device.

17. (canceled)

18. The method of claim 13, wherein a data channel that is mapped to two slots consecutively is split into two parts, wherein a first part is within a first slot and a second part is within a second slot, and the two parts are transmitted separately.

19. The method of claim 2, wherein a transport block carried in the plurality of data channels is determined by a total resource size of the plurality of data channels, and a set of bits for a plurality of subsequent data channels is selected from a circular buffer by following a last bit for a previous data channel of the plurality of data channels.

20. (canceled)

21. The method of claim 2, wherein the plurality of data channels includes at least one of a physical downlink shared channel, a physical uplink shared channel, or a physical sidelink shared channel, and the control information includes at least one of downlink control information, sidelink control information, a medium access control-control element, or radio resource control signaling.

22. A wireless communications apparatus comprising a processor and a memory, wherein the processor is configured to read code from the memory to:
receive control information to schedule a plurality of data channels transmitted in a plurality of carriers, wherein the control information indicates a resource of plurality of data channels, and the plurality of data channels are ordered according to an order determined by at least one of a frequency domain or a time domain; and
communicate the plurality of data channels in the plurality of carriers according to the resource and the order.

23. (canceled)
